(19) United States
(12) Patent Application Publication
(10) Pub. No.: US 2016/0147702 A1
(43) Pub. Date: May 26, 2016

(54) COMMUNICATION CONTROL DEVICE, METHOD OF COMMUNICATING A FRAME, AND STORAGE MEDIUM

(71) Applicant: FUJITSU LIMITED, Kawasaki-shi (JP)

(72) Inventors: Jun YAJIMA, Kawasaki (JP); Masahiko Takenaka, Kawasaki (JP)

(73) Assignee: FUJITSU LIMITED, Kawasaki (JP)

(21) Appl. No.: 14/944,589

(22) Filed: Nov. 18, 2015

(30) Foreign Application Priority Data
Nov. 25, 2014 (JP) 2014-238172

(51) Int. Cl. G06F 13/42; G06F 11/07

(52) U.S. Cl. CPC G06F 13/4221; G06F 11/0763; G06F 11/0745

(57) ABSTRACT

A communication control device includes a plurality of ports, a memory, and a processor. The memory stores one or more pieces of identification information correlated with each of one or more of the plurality of ports to which a communication device has been coupled, the one or more pieces of identification information being included in a frame for transmission of the frame by one or more communication devices each coupled to the one or more ports. The processor outputs, to the plurality of ports, a frame in which has been set second identification information regarding which determination will be made at the one or more communication devices that the frame is to be discarded, instead of the first identification information, when first identification information in a frame received at a first port of the one or more ports is not stored in the memory correlated with the first port.

### CROSS-REFERENCE TO RELATED APPLICATION

This application is based upon and claims the benefit of priority of the prior Japanese Patent Application No. 2014-238172, filed on Nov. 25, 2014, the entire contents of which are incorporated herein by reference.

### FIELD

The present embodiment relates to control of communication between communication devices.

### BACKGROUND

There are cases where a network technology called Controller Area Network (CAN) is used to transmit/receive data and control information between devices used in an automobile onboard network, factory automation, and so forth. In CAN technology, a CAN hub may be used to couple devices called electronic control units (ECU).

FIG. 1 illustrates an example of transmission/reception of frames in a system including a CAN hub 10. In the example in FIG. 1, ECUs 5 (5a, 5b, and 5c) are coupled to the CAN hub 10. The CAN hub 10 outputs signals input from a certain port to all ports, via CAN transceivers 11 (11a, 11b, and 11c) and a communication arbitration unit 12. In a case where multiple frames are transmitted at the same time, the communication arbitration unit 12 decides a frame to be output. Frames used for communication include identification information (ID). Each ECU stores identification information of frames to be received, beforehand.

For example, an arrangement will be assumed where the ECU 5b receives a frame with ID “789”, and the ECU 5c receives a frame with ID “123”. The ECU 5a is set to transmit a frame with ID “123” or ID “456”. For example in a case where the ECU 5a transmits a frame F1 regarding which an ID of 123 has been specified, the frame F1 is output from all ports that the CAN hub 10 has, so the frame F1 is output toward all of the ECUs 5a through 5c, as illustrated in FIG. 1. The frame ID for reception at the ECU 5b is 789, so the ECU 5b discards the frame F1. The frame ID for reception at the ECU 5c is 123, so the ECU 5a receives the frame F1, and performs processing as appropriate.

FIG. 2 illustrates an example of a case where transmission processing is performed using an ID not set as an ID for use in transmission processing. Assumption will be made regarding an example where the ECU 5a has been externally attacked, and thus has transmitted a frame F2 in which is set an ID “789” which is not set as an ID to be used for transmission processing. The frame F2 is also output from all ports, and accordingly the frame F2 is transmitted toward the ECUs 5a through 5c. The ECU 5b set to receive the frame with ID “789” receives the frame F2, but the ECU 5c discards the frame F2. Thus, due to the ID used for transmission processing by the ECU 5a having been changed, the ECU 5b receives the frame from the ECU 5a which the ECU 5b originally is not intended to receive, as the frame F2, and performs the processing of the frame F2. In this way, the frame F2, including data which originally is not intended to be processed at the ECU 5b, is processed by the ECU 5b, which may lead to system problems.

Technology has been conceived to avoid the ECUs 5 from receiving such unauthorized frames. For example, a proposal has been made to correlate the ports of the CAN hub 10 with the IDs that the ECUs 5 coupled thereto use for transmission, and to cut the wiring between the port where the frame including the uncorrelated ID has been input and the communication arbitration unit 12, using a switch. There also has been proposed as related art an automobile onboard communication system that stops transmitting data when detecting continuous data transmission by the same source for a predetermined amount of time or longer.

As examples of related art, Japanese Laid-open Patent Publication No. 2004-356889, and Sekiguchi Daiki et al., “White-List Hub: A Network Component to Suppress Unauthorized CAN Data Transmission”, Proceedings of the Symposium on Cryptography and Information Security SCIS 2014, The Institute of Electronics, Information and Communication Engineers, January 2014, SCIS 2014-2-C1-1 are known.

### SUMMARY

According to an aspect of the invention, a communication control device including a plurality of ports, the communication control device includes: a memory configured to store one or more pieces of identification information correlated with each of one or more of the plurality of ports to which a communication device has been coupled, the one or more pieces of identification information being included in a frame for transmission of the frame by one or more communication devices each coupled to the one or more ports; and a processor configured to: when first identification information for identifying a first frame in the first frame received at a first port of the one or more ports is not stored in the memory correlated with the first port, output, to the plurality of ports, a second frame in which has been set second identification information regarding which determination will be made at the one or more communication devices that the second frame is to be discarded, instead of the first identification information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of transmission/reception of frames that is performed in a system including a controller area network (CAN) hub;

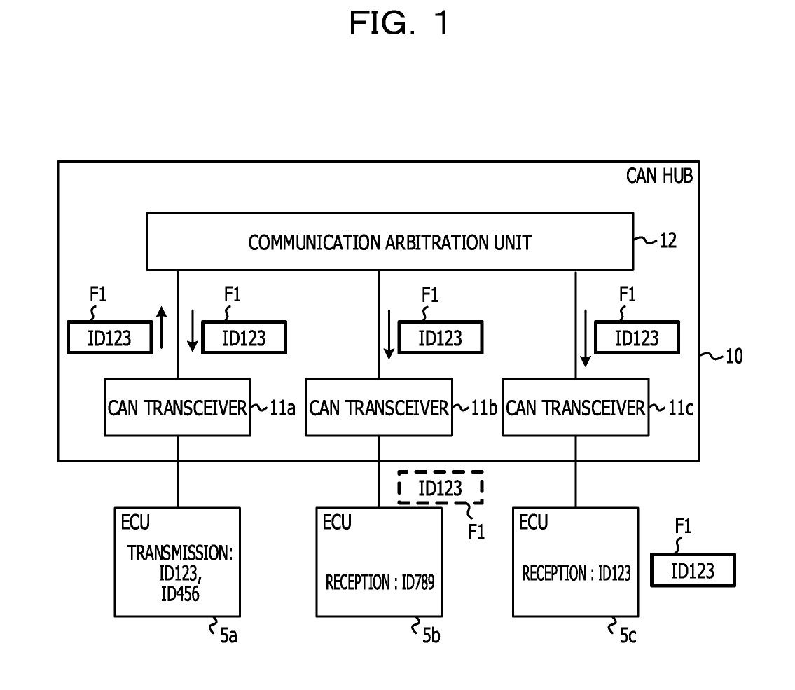

FIG. 2 illustrates an example of a case where transmission processing is performed using an ID not set as an ID for use in transmission processing;

FIG. 3 illustrates an example of a communication control device according to an embodiment;

FIG. 4 illustrates an example of a communication control method according to a first embodiment;

FIG. 5 illustrates an example of a hardware configuration of a communication control device;

FIG. 6 illustrates examples of formats of frames that are transmitted/received;

FIG. 7 is a diagram for describing an example comparison processing;

FIG. 8 illustrates an example of an unused ID list;

FIG. 9 is a flowchart for describing an example of processing performed at the control unit;

FIG. 10 illustrates an example of the configuration of a communication control device according to a second embodiment;

FIG. 11 is a flowchart for describing an example of processing performed at the control unit;

FIG. 12 illustrates an example of the configuration of a communication control device according to a third embodiment;

FIG. 13 illustrates an example of a used ID list; and

FIG. 14 is a flowchart for describing an example of processing performed at the control unit.

### DESCRIPTION OF EMBODIMENTS

It is difficult for the related art to protect a system from an attack using unauthorized frames. For example, even if wiring used to input an unauthorized frame is cut, the bit string read in to determine whether or not the input frame is unauthorized may be input to the Controller Area Network (CAN) hub in fragments, and may be output from the ports of the CAN hub. If frame fragments are output to the ports, one or more errors are detected at the ECUs coupled to the ports. This may lead to system congestion due to error frames being output from the ECUs. Also, in the case of a system that stops data transmission upon continuous data transmission for a predetermined period or longer, transfer of unauthorized frames is not avoided unless the unauthorized frames are transmitted consecutively.

Embodiments are described hereinafter which aim to improve the resistance of systems as to attacks using unauthorized frames.

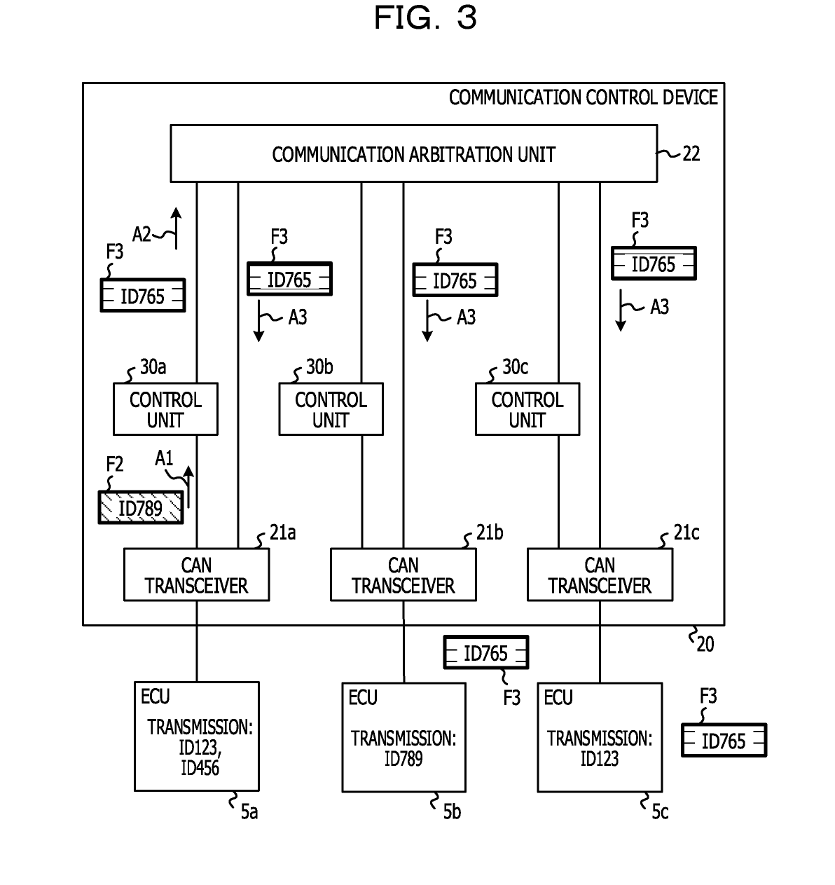

FIG. 3 illustrates an example of a communication control method according to an embodiment. The communication control device 20 stores beforehand, for each port, identification information which the ECU 5 coupled to that port uses for transmission processing. Further, the communication control device 20 stores information for identifying identification information not transmitted by any ECU 5 coupled to any port. For example, information identifying identification information not transmitted by any ECU 5 coupled to any port may be information in an optional format, including a list of identification information not transmitted by any ECU 5 coupled to any port.

The control units 30 in the communication control device 20 determine whether or not the identification information of the frame input from the CAN transceiver 21 (first identification information) matches identification information correlated with the reception port for that frame. In the case that there are multiple pieces of identification information correlated with one port, determination is made regarding whether or not any one of the identification information correlated with the reception port match the first identification information.

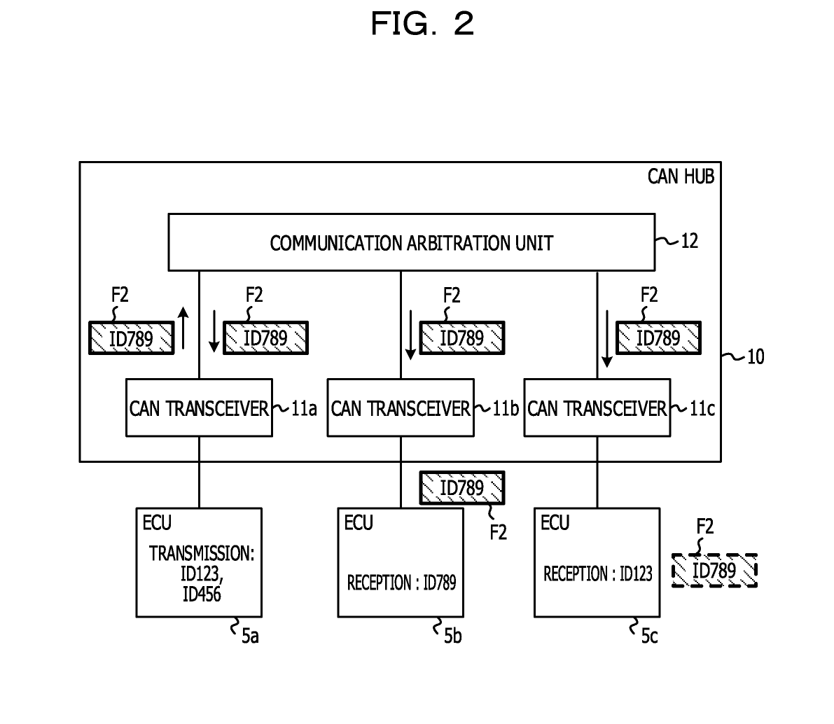

For example, in the example in FIG. 3, the ECU 5a uses an ID “123” and an ID “456” for transmission processing, when operating normally. However, assumption will be made there that a the ECU 5a has been externally attacked, in the same way as in the case in FIG. 2, and has transmitted a frame F2 in which is set an ID “789” which is not set as an ID to be used for transmission processing. The control unit 30a then acquires the frame F2 transmitted from the ECU 5a via the CAN transceiver 21a, as indicated by procedure A1. Accordingly, in the case in FIG. 3, the first identification information is the information identifying the frame F2 (ID “789”). Further, the control unit 30a determines whether the first identification information matches any one of the identification information correlated with the reception pots for the frame F2. In the case in FIG. 3, the control unit 30a identifies that while the first identification information is ID 789, the ID “789” is not correlated with the reception port for the frame F2. The control unit 30a then outputs a frame (frame F3) in which identification information that is not the object of reception at any of the ECUs 5 to the communication arbitration unit 22 (procedure A2). The identification information of the frame F3 here is ID “765”.

Upon the frame F3 (ID “765”) being input to the communication arbitration unit 22, the communication arbitration unit 22 outputs the frame F3 to the ports (procedure A3). Accordingly, the frame F3 is transmitted to the ECU 5a, ECU 5b, and ECU 5c. The ID is “765” for the frame F3 input from the communication control device 20, so the ECU 5b determines that the frame F3 is not an object of reception, and discards the frame F3. In the same way, the ECU 5c also determines that the frame F3 is not an object of reception, and discards the frame F3.

Thus, transfer of unauthorized frames to the ECUs 5 may be avoided by the method of this embodiment. Also, transfer of unauthorized frame is avoided even if unauthorized frames are not continuously transmitted. Further, there is no occurrence of congestion of error frames due to frame fragments being transmitted and received over the network. Thus, the system may be protected from attacks using unauthorized frames, by using the method of this embodiment. In other words, resistance to attacks is strengthened in the system using the communication control device 20.

### First Embodiment

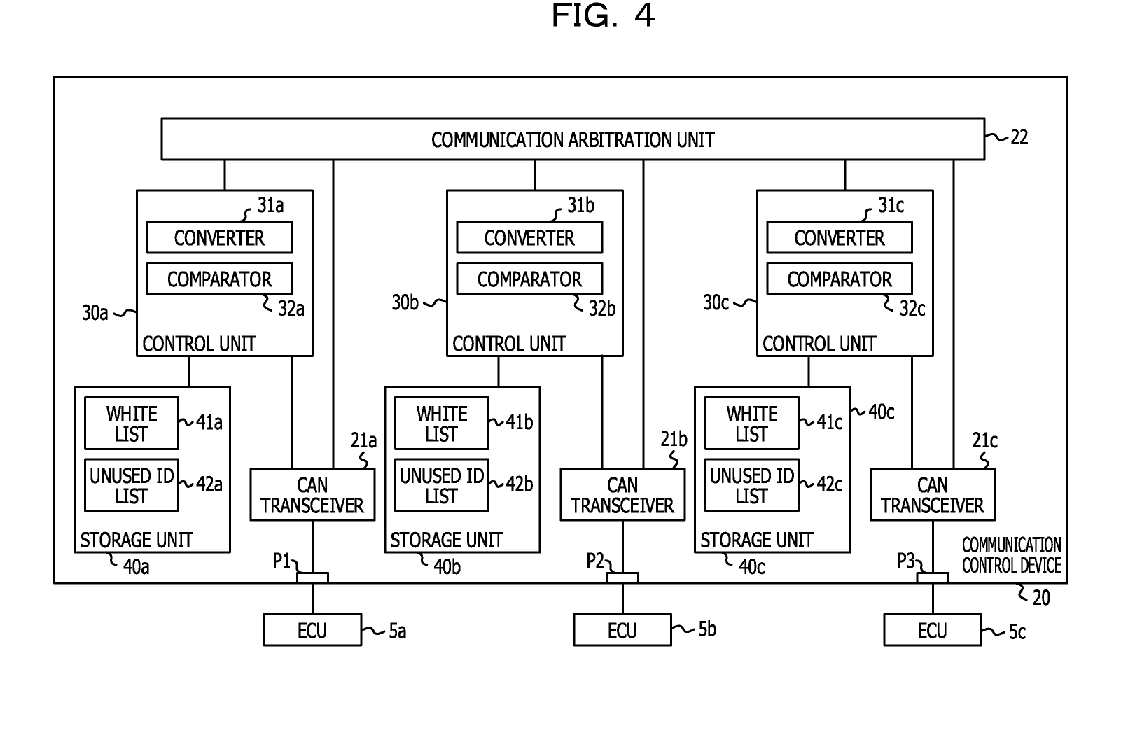

FIG. 4 illustrates a configuration example of a communication control device 20 according to a first embodiment. The communication control device 20 includes ports (P1, P2, and P3), CAN transceivers 21 (21a, 21b, and 21c), the communication arbitration unit 22, control units 30 (30a, 30b, and 30c), and storage units 40 (40a, 40b, and 40c). The control units 30 each have a converter 31 and comparator 32. The storage units 40 store a white list 41 and unused ID list 42.

The white list 41 correlates identification information to be used by the ECUs 5 coupled to the ports provided to the communication control device 20 for transmission of frames, with the ports. In a case where a white list 41 is generated for each port as illustrated in FIG. 4, each white list 41 stores identification information which the ECU 5 coupled to the port correlated with that white list 41 uses for frame transmission. For example, the white list 41a is correlated with port P1, so the ECU 5a coupled to the port P1 stores the identification information used for transmission processing. In the same way, the white list 41b is used for processing of frames input from port P2, so the ECU 5b coupled to the port P2 stores the identification information used for transmission processing. Further, the white list 41c is correlated with port P3, so the ECU 5c coupled to the port P3 stores the identification information used for transmission processing. The unused ID lists 42a through 42c store identification information which is not the object of reception regarding any of the ECUs 5 coupled to the communication control device 20.

The CAN transceivers 21 perform processing such as generating bus transmission voltage for transmission/reception of frames with the ECUs 5, adjustment of bus transmission voltage, and so forth. Each CAN transceiver 21 outputs frames input from the ECUs 5 to the comparator 32 within the control unit 30 coupled to that CAN transceiver 21. For example, the CAN transceiver 21a outputs the frame received from the ECU 5a to the comparator 32a in the example in FIG. 4.

Inside each control unit 30, a comparator 32 compares the source information of a frame input from the CAN transceiver 21 with the identification information stored in the white list 41. In a case where the source information of the input frame matches any one of the identification information stored in the white list 41 correlated with the port at which the frame has been received, the comparator 32 outputs the input frame to the communication arbitration unit 22. That is to say, the comparator 32 handles a received frame of which the source is identification information registered in the white list 41 correlated with the reception port, as a frame transmitted from a normal ECU 5. On the other hand, in a case where the source of the input frame does not match any one of the identification information correlated with the port at which the frame has been received, the comparator 32 notifies a converter 31 that an unauthorized frame has been input. Note that along with notification of input of an unauthorized frame, the comparator 32 also notifies the converter 31 of the bit string out of the ID of the received frame that has already been output to the communication arbitration unit 22.

Upon being notified from the comparator 32 that an unauthorized frame has been input, the converter 31 changes the identification information of the input frame into identification information that will not be received at any ECU 5. The converter 31 performs processing to output the frame of which the identification information has been changed to the communication arbitration unit 22. The communication arbitration unit 22 outputs the input frame toward all ports. In a case where multiple frames are input to the communication arbitration unit 22 simultaneously, the communication arbitration unit 22 selects one of the simultaneously input frames as a frame to be transferred. The communication arbitration unit 22 outputs the frame selected to be transferred to all ports.

While the example in FIG. 4 illustrates an example of a case where there are three ports coupled to the ECUs 5, the number of ports which the communication control device 20 uses for communication with the ECUs 5 is optional. Also, while FIG. 4 illustrates an example of a case where one control unit 30 and one storage unit 40 is provided for each port, the processing performed at the control units 30a through 30c may be performed at a single control unit 30, and the information sorted at the storage units 40a through 40c may be stored in a single storage unit 40.

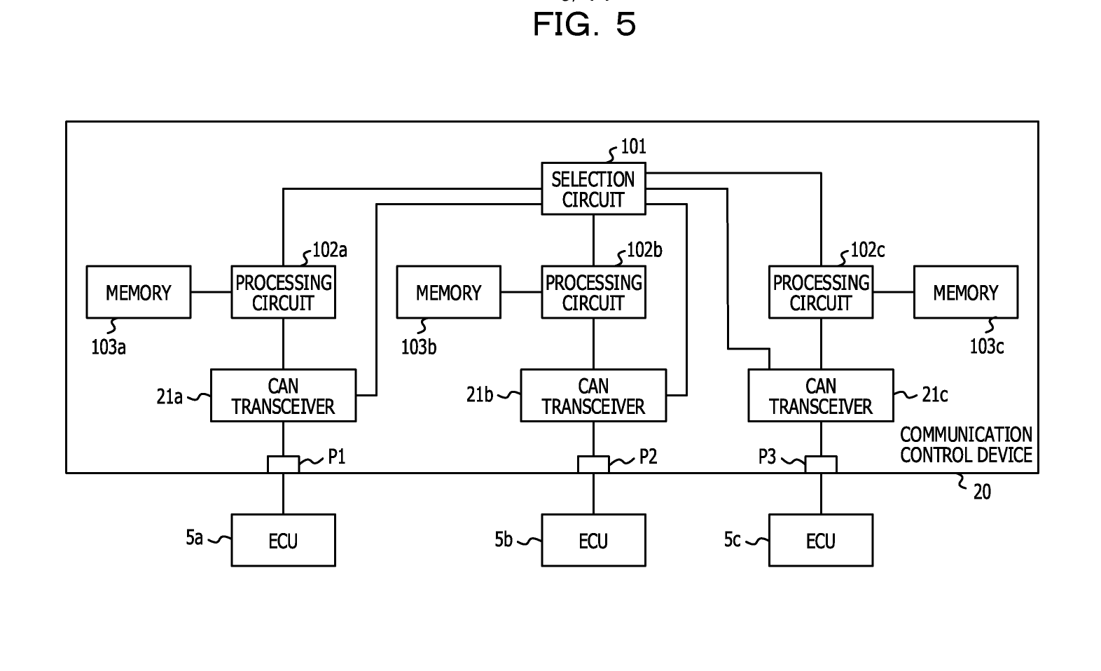

FIG. 5 is an example of the hardware configuration of the communication control device 20. Although FIG. 5 also illustrates a case where the number of ports is three, the number of ports of the communication control device 20 may be optionally decided according to the implementation. The communication control device 20 includes a selection circuit 101, processing circuits 102 (102a, 102b, and 102c), memory 103 (103a, 103b, and 103c), CAN transceivers 21 (21a, 21b, and 21c), and ports (P1, P2, and P3). The selection circuits 101 are all optional ports which can select frames transmitted from the communication control device 20 out of multiple frames input thereto at the same time, and operate as the communication arbitration unit 22. The processing circuits 102 each use information stored in memory 103 to operate as the control units 30, as suitable. The memory 103 operates as the storage units 40. The communication control device 20 may be realized as a junction box, hub, repeater hub, or the like, for example.

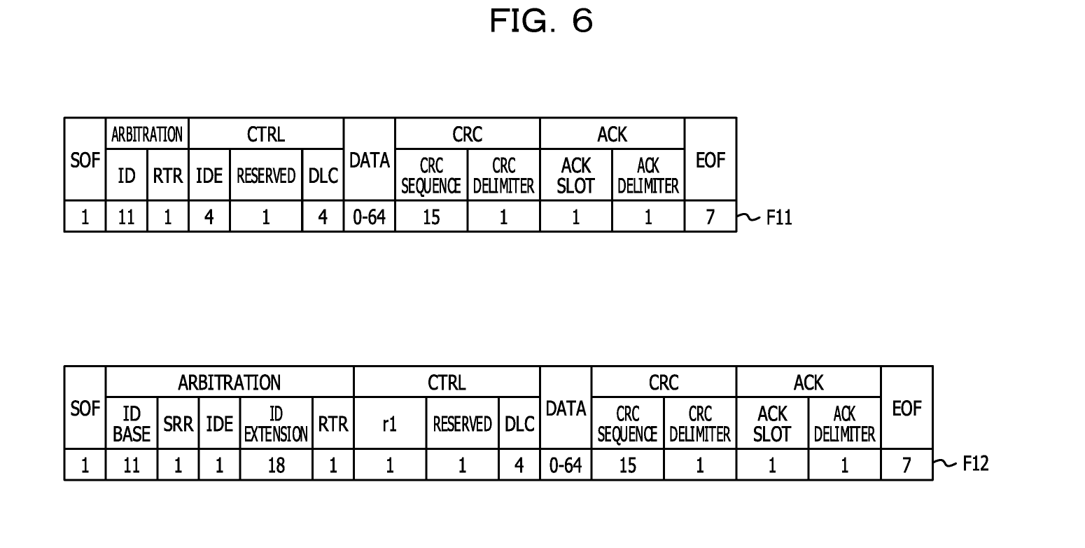

FIG. 6 illustrates examples of formats of frames that are transmitted and received. F11 in FIG. 6 is a frame format example for a general CAN specification, while F12 is a frame format example used in an extended CAN specification.

The general specification frame includes a Start of Frame (SOF), arbitration field, control field, data field, Cyclic Redundancy Check (CRC) field, acknowledge (ACK) field, and End of Frame (EOF). The arbitration field includes an ID and Remote Transmission Request (RTR). The ID is the identification information of the ECU 5 which is the source. The control field includes Identifier Extension (IDE), a reserved bit, and Data Length Code (DLC). The CRC field includes a CRC sequence and CRC delimiter. The ACK field includes an ACK slot and ACK delimiter. The bottom row of the F11 lists the bit lent of the information components included in each field. For example, the ID is 11 bits long, while the data field is variable in length, between 0 to 64 bits.

The frame used in the extended specification (F12) also includes an SOF, arbitration field, control field, data field, CRC field, ACK field, and EOF. The arbitration field in the extended specification includes an ID base and Substitute Remote Request Bit (SRR), IDE, ID extension, and RTR. The identification information (ID) of the source in the extended specification is represented by a bit string obtained by appending a bit string stored as an extension ID following the bit string stored as an ID base. From the control field up to the EOF is the same as in the general specification format. The bottom row of the F12 lists the bit length of the information components included in each field in the extended specification format as well. Accordingly, a bit string of 29 bits, obtained by adding the 11 bits of the ID base to the 18 bits of the ID extension, is used in the extended format as identification information of the source.

An example of processing performed in the first embodiment will be described below, as an example where an unauthorized format using the format illustrated in F11 in FIG. 6 has been transmitted from the ECU 5a to the communication control device 20. Note that the same processing is performed in the case where the frame used for communication is of the extended specification as well.

A frame which the ECU 5a has transmitted to the communication control device 20 is output to the comparator 32a via the port P1 and the CAN transceiver 21a. The comparator 32a outputs the SOF of the input frame to the communication arbitration unit 22. Next, the comparator 32a compares the ID of the frame with the identification information correlated with the reception port P1, using the white list 41a.

The control unit 30 performs comparison of the ID and white list 41 in parallel with output to the communication arbitration unit 22, in order to reduce delay time from reception of the frame at the communication control device 20 to transfer of the frame. In other words, before having acquired the entire ID of the frame being transmitted from the ECU 5a, the comparator 32 determines whether or not an unauthorized frame while outputting the input bits to the communication arbitration unit 22.

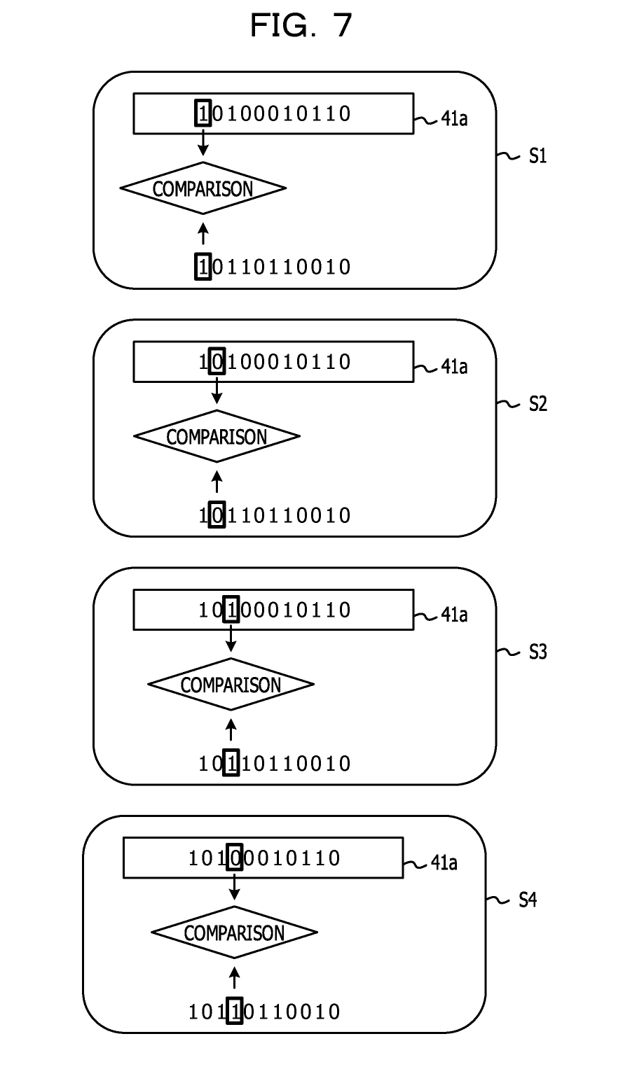

FIG. 7 is a diagram for describing an example of comparison processing at the comparator 32. In the example in FIG. 7, a case will be assumed where identification information 10100010110 is recorded in the white list 41a, but the ID of the frame input to the comparator 32 is 10110110010. Although a case where the number of identification information registered in the white list 41a is one is illustrated in the example in FIG. 7 to facilitate understanding, the number of identification information stored in each of the white lists 41 is optional. Also, to facilitate understanding in the following description, a frame received from the ECU 5a may be written as “first frame”. Further, a frame that has a replaced ID in a case where the first frame has been determined to be an unauthorized frame may be written as “second frame”.

Step S1 is an example of comparison processing of the first bit of the ID (first identification information) in the frame (first frame) which the communication control device 20 has received, and the first bit of the identification information in the white list 41a. Of the two bit strings illustrated in step S1, the lower bit string is the ID within the first frame. Note that FIG. 7 illustrates the entire first identification information for sake of convenience, to facilitate understanding of the position of the bit being used for the comparison processing within the first identification information. Upon acquiring the first bit of the ID of the first frame, the comparator 32a performs comparison processing. Since the value of the first bit in the first identification information is 1, and the white list 41a contains identification information that starts from 1, the comparator 32a determines that there is a possibility that the first frame is not an unauthorized frame. Accordingly, the comparator 32a outputs the first bit of the first identification information to the communication arbitration unit 22.

In step S2, the comparator 32a identifies the identification information out of the identification information in the white list 41a regarding which the first bit has matched the first identification information. The comparator 32a further compares the value of the second bit of the identified identification information with the value of the second bit of the first identification information. In other words, the comparator 32a determines whether or not the bit string of the first two bits of the first identification information matches the first two bits of any identification information in the white list 41a. In the example illustrated in step S2, identification information of 10100010110 in the white list 41a is identified, so the value of the second bit is 0, and the value of the second bit in the first identification information also is 0. Based on the comparison results between the first and second bits of the first identification information and the white list 41a, the comparator 32a determines that there is a possibility that the first frame is not an unauthorized frame. Accordingly, the comparator 32a outputs the second bit of the first identification information to the communication arbitration unit 22.

Thereafter, the comparator 32a repeats the same processing as that in step S2 until the value of the first identification information is determined to not match the identification information recorded in the white list 41a. The comparator 32a performs the same processing in step S3 as that in step S2 in the example in FIG. 7. As a result, the first through third bits of the first identification information match the identification information in the white list 41a, so the comparator 32a determines that there is a possibility that the first frame is not an unauthorized frame. The third bit of the first identification information is output to the communication arbitration unit 22.

In step S4, the comparator 32a compares the value of the fourth bit of the identification information in the white list 41a with the value of the fourth bit of the first identification information, by processing the same as that in steps S2 and S3. In step S4, the value of the fourth bit if the first identification information is 1, but the value of the fourth bit in the identification information used for comparison processing in the white list 41a is 0. There is no identification information recorded in the white list 41a regarding which the values of the first through fourth bits match the first through fourth bits of the first identification information, so the comparator 32a determines that the first frame is an unauthorized frame. The comparator 32a notifies the converter 31a that an unauthorized frame has been detected. The comparator 32a does not output the value of the fourth bit of the first identification information communication arbitration unit 22. Now, at this point, the first through third bits of the first identification information has already been output to the communication arbitration unit 22. Accordingly, the comparator 32a notifies the converter 31a of the values of the first through third bits of the first identification information.

The converter 31a selects identification information that will not be received at any of the ECUs 5 and that includes at the start thereof the bit string already output to the communication arbitration unit 22, as second identification information. The converter 31a uses the unused ID list 42a as suitable at this time. The converter 31a further performs processing to output the selected identification information to the communication arbitration unit 22 as a substitute for the first identification information representing the source of the unauthorized first frame.

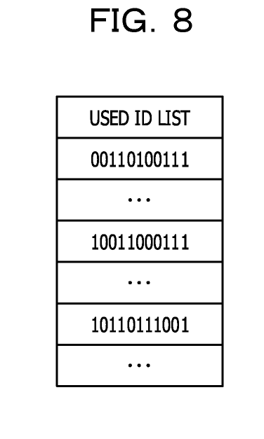

FIG. 8 illustrates an example of an unused ID list 42a. The comparator 32a detects that the input frame is an unauthorized frame after having output the three first bits of the first identification information to the communication arbitration unit 22 in the example illustrated in FIG. 7. Accordingly, as far as the bit string 101 has been output to the communication arbitration unit 22 as the ID. The converter 31a thus selects identification information which has 101 as the first three bits from the identification information stored in the unused ID list 42a, as the second identification information to be output to the communication arbitration unit 22 instead of the first identification information. In the example in FIG. 8, assumption is made that the converter 31a has selected identification information 10110111001 from the unused ID list 42a.

The converter 31a outputs a bit string obtained by deleting the number of bits already output to the communication arbitration unit 22 from the start of the identification information selected as the second identification information, to the communication arbitration unit 22 as the continuation of the ID. In the example illustrated in FIG. 7, the first three bits (101) of the first identification information have already been output to the communication arbitration unit 22 when the frame was detected as being unauthorized. Accordingly, the converter 31a outputs the fourth bit and thereafter of the second identification information selected from the unused ID list 42a (10111001) to the communication arbitration unit 22. Accordingly, the ID input to the communication arbitration unit 22 is “10110111001”. In other words, the converter 31a can be said to be converting the unauthorizedly-transmitted first frame into a second frame that will not be received at any ECU 5, by changing part of the ID (first identification information) of the first frame.

When the processing to change the ID at the converter 31a ends, the comparator 32a outputs the bit string following the ID in the first frame to the communication arbitration unit 22. Accordingly, following the change ID, the RTR, control field, data field, CRC field, ACK field, and EOF, of the first frame, are input to the communication arbitration unit 22. Due to this processing, the communication arbitration unit 22 has received input of the second frame where the ID has been changed to the second identification information.

The communication arbitration unit 22 outputs the input second frame to the ports. The communication arbitration unit 22 is coupled with the CAN transceivers 21 (21a through 21c) as illustrated in FIG. 4, and outputs the second frame to the CAN transceivers 21 without going through the control units 30. The second frame is transmitted to all ECUs 5 coupled with the communication control device 20, via the CAN transceivers 21a through 21c. However, the ID of the second frame is a value which will not be received at any of the ECUs 5, so the second frame is not received at any of the ECUs 5 and does not become the object of processing. Thus, the system is protected from attacks using frames in which unauthorized IDs have been set.

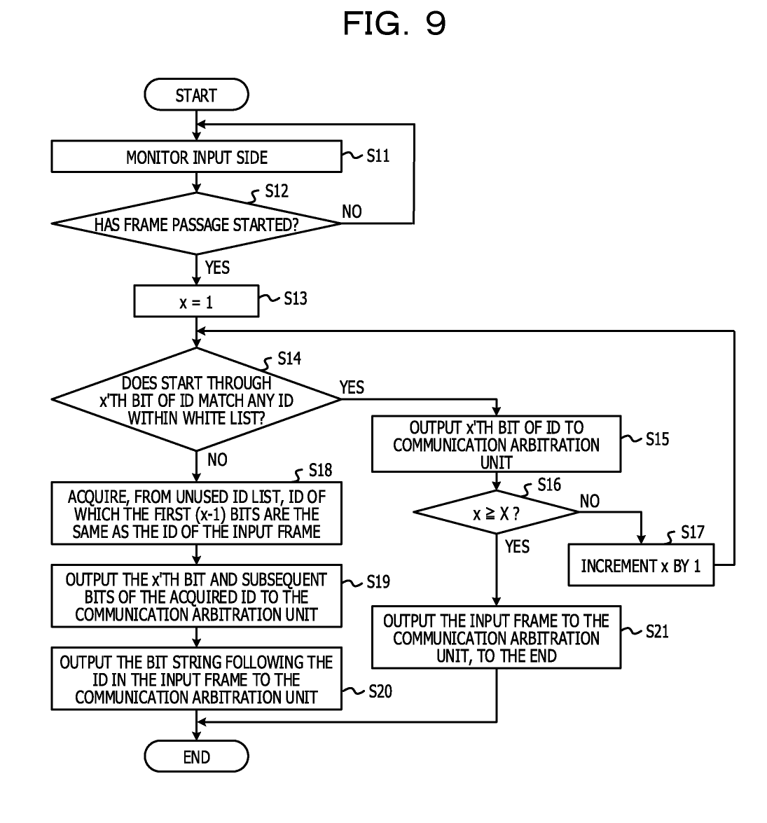

FIG. 9 is a flowchart for describing an example of processing performed at the control units 30. Note that in the example in FIG. 9, a constant X and a variable x are used. The variable x is used to count the number of bits of the ID of the input frame that have been compared with the identification information in the unused ID list 42. The constant X is the total number of bits used to describe the ID in the frame used for communication. The processing illustrated in FIG. 9 is only an example, and the processing may be changed depending on the implementation, such as the processing of step S13 being performed first, for example.

The comparator 32 monitors data input from the wiring between itself and the CAN transceiver 21 which is the input side for frames, and determines whether or not passage of a frame has started (steps S11 and S12). The comparator 32 determines whether passage of a frame has started using the SOF of the received frame. For example, the comparator 32 may determine that passage of a frame has started upon input of a SOF, or may passage of a frame has started upon outing of the SOF to the communication arbitration unit 22. Upon passage of a frame having started, the comparator 32 sets the variable x to 1 (Yes in step S12, step S13). The comparator 32 determines whether the bit string from the start of the ID to the x'th bit matches any identification information included in the white list 41 (step S14). The determination method performed at the comparator 32 is the same as that described with reference to FIG. 7. In a case where the bit string from the start of the ID to the x'th bit matches any identification information included in the white list 41, the comparator 32 outputs the x'th bit of the ID to the communication arbitration unit 22 (Yes in step S14, step S15). The comparator 32 determines whether the value of the variable x is equal to or larger than the constant X (Step S16). In a case where the value of the variable x is smaller than the constant X, the comparator 32 increments the variable x by 1, and returns to step S14 (No in step S16, step S17).

On the other hand, in a case where the bit string from the start of the ID to the x'th bit does not match any identification information included in the white list 41, the comparator 32 notifies the converter 31 that the input frame is an unauthorized frame (No in step S14). The comparator 32 also notifies the converter 31 of the bit string of (x−1) bits out of the ID of the unauthorized frame (first identification information), that have already been output to the communication arbitration unit 22. The converter 31 acquires an ID (second identification information) from the unused ID list 42 regarding which the first (x−1) bits of the ID are the same as the first (x−1) bits of the first identification information (step S18). The processing example performed in step S18 is that which has been described with reference to FIG. 8. The converter 31 further outputs the x'th bit and subsequent bits in the acquired ID to the communication arbitration unit 22 (step S19). Accordingly, the ID which the converter 31 has selected is input to the communication arbitration unit 22 as the ID. Upon the input processing from the converter 31 to the communication arbitration unit 22 ending, the comparator 32 outputs the bit string from the input frame, following the ID, to the communication arbitration unit 22 (step S20). Accordingly, the communication arbitration unit 22 inputs a second frame where the first identification information in the unauthorized first frame has been replaced by second identification information that will not be received by any of the ECUs 5, by the processing of steps S19 and 20. It can be said that the control unit 30 generates the second frame from the first frame in this processing.

On the other hand, in a case where the value of the variable x is equal to or larger than the constant X in step S16, the ID of the input frame matches the identification information in the white list 41, so the comparator 32 determines that the input frame is not an unauthorized frame (Yes in step S16). The comparator 32 further outputs to the communication arbitration unit 22 input frames to the end (step S21). In this case, the received frame is output to the communication arbitration unit 22, so the communication arbitration unit 22 outputs the received frame to the ports.

As described above, using the first embodiment avoids the ECUs 5 receiving unauthorized frames. Further, a frame including second identification information is transmitted from the communication arbitration unit 22 instead of the first identification information, so congestion of error messages due to frame fragments being transmitted to the ECUs 5 is also avoided.

This sort of processing is particularly advantageous in a case of avoiding attacks using unauthorized IDs in a system which performs real-time processing of frames input from the ports in the communication control device 20. That is to say, the communication control device 20 does not buffer the frames received from the ECUs 5, in order to reduce delay as much as possible in processing where frames are handled in real time. Accordingly, the comparator 32 performs determination processing before acquiring the entire ID, and in a case where there is a possibility that the received frame is not an unauthorized frame, transmits the values of the input bits to the ports via the communication arbitration unit 22. Accordingly, at the stage of having detected that the value of the ID does not exist in the white list 41 and that the input frame is an unauthorized frame, part of the ID of the frame already has been output to the ports via the communication arbitration unit 22. Accordingly, the converter 31 selects, of identification information that will not be received at any of the ECUs 5, an ID including the bit string already output to the communication arbitration unit 22 at the start thereof. Of the selected identification information, the converter 31 also outputs to the communication arbitration unit 22 the continuing portion from the bit string already output to the communication arbitration unit 22, thus converting unauthorized frames into frames that will not be received at any ECU 5. Thus, according to the first embodiment, the system is protected from attacks using unauthorized frames, without interfering with processing where real-time handling of frames is important.

### Second Embodiment

Description will be made in the second embodiment regarding a case where a CRC sequence value output to the communication arbitration unit 22 is calculated each time an ID change is performed. Using the second embodiment enables prevention of CRC errors due to frames transmitted instead of unauthorized frames being detected at the ECUs 5, even in cases where a check is performed using CRC regarding frames which the ECUs 5 do not handle as objects of reception.

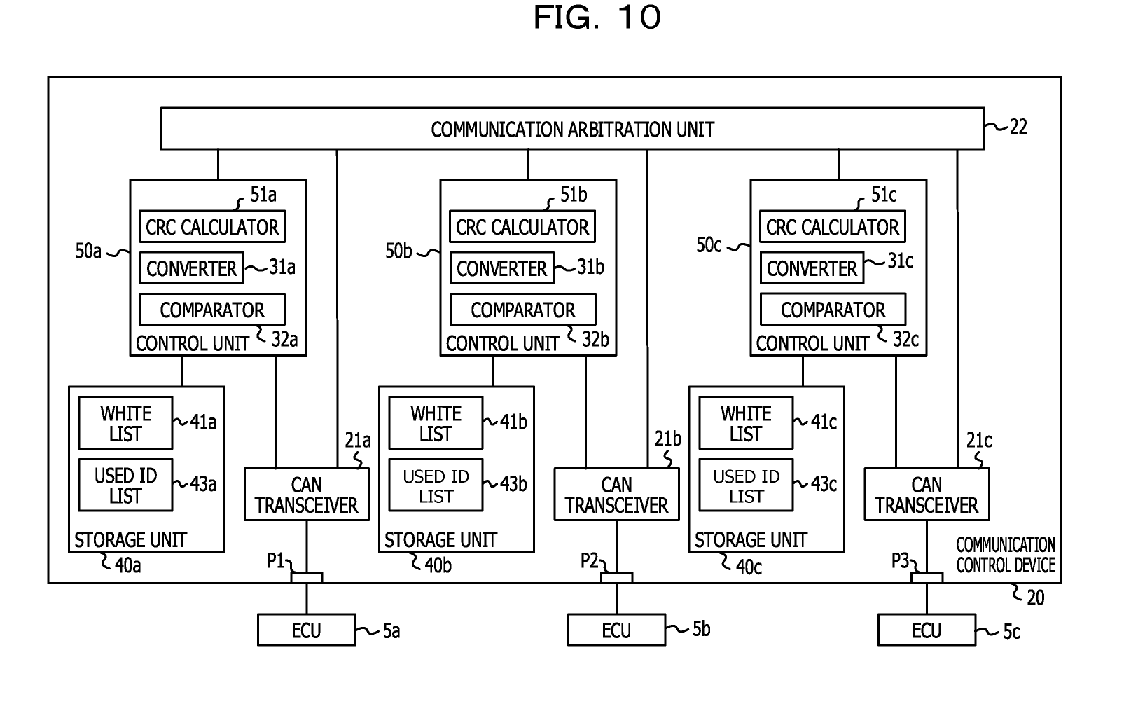

FIG. 10 illustrates an example of the configuration of a communication control device 60. The communication control device 60 includes ports (P1, P2, and P3), CAN transceivers 21 (21a, 21b, and 21c), the communication arbitration unit 22, control units 50 (50a, 50b, and 50c), and storage units 40 (40a, 40b, and 40c). The control units 50 each have a converter 31, comparator 32, and CRC calculator 51. The operations of the CAN transceivers 21, communication arbitration unit 22, and converters 31, are the same as in the first embodiment. The information stored in the storage units 40 is the same as in the first embodiment. Note that the control units 50 are realized by the processing circuits 102 (FIG. 5).

Upon a frame being input in the second embodiment, the comparator 32 requests the CRC calculator 51 to start processing for CRC calculation, and outputs information output to the communication arbitration unit 22, to the CRC calculator 51 as well. The CRC calculator 51 stores the values of the bits input from the comparator 32.

In a case where the first frame is an unauthorized frame, the comparator 32 which has detected that the input first frame is an unauthorized frame notifies the converter 31 of detection of an unauthorized frame, in the same way as with the first embodiment. In the second embodiment, the converter 31 also outputs information to be output to the communication arbitration unit 22 to the CRC calculator 51. The CRC calculator 51 uses the information input from the comparator 32 and the information input from the converter 31 to acquire second identification information to be output instead of the first identification information set in the unauthorized first frame.

Upon input of the second identification information by the converter 31 ending, the comparator 32 outputs information of the data field in the first frame to the communication arbitration unit 22 and the CRC calculator 51. The CRC calculator 51 calculates the CRC sequence value using the second identification information, the data field value included in the first frame, and so forth.

Upon input of the data field ending, the comparator 32 requests the CRC calculator 51 to output the calculation results for the CRC sequence. The CRC calculator 51 outputs the calculated value to the communication arbitration unit 22 as a CRC sequence. When output of the CRC sequence ends, the comparator 32 outputs values after the CRC delimiter in the first frame to the communication arbitration unit 22.

As a result of this processing, a second frame with the ID and CRC of the first frame having been changed is input to the communication arbitration unit 22 instead of the unauthorized first frame transmitted from the ECU 5. The processing of the communication arbitration unit 22 outputting the second frame to the ports is the same as that in the first embodiment.

The ID of the second frame is set to a value that will not be received at any of the ECUs 5, the same as in the first embodiment. Further, the CRC sequence value input to the communication arbitration unit 22 is a value that has been calculated by the CRC calculator 51 using the ID and data field values of the second frame. Accordingly, even if a CRC check is performed regarding the second frame, no CRC errors will occur.

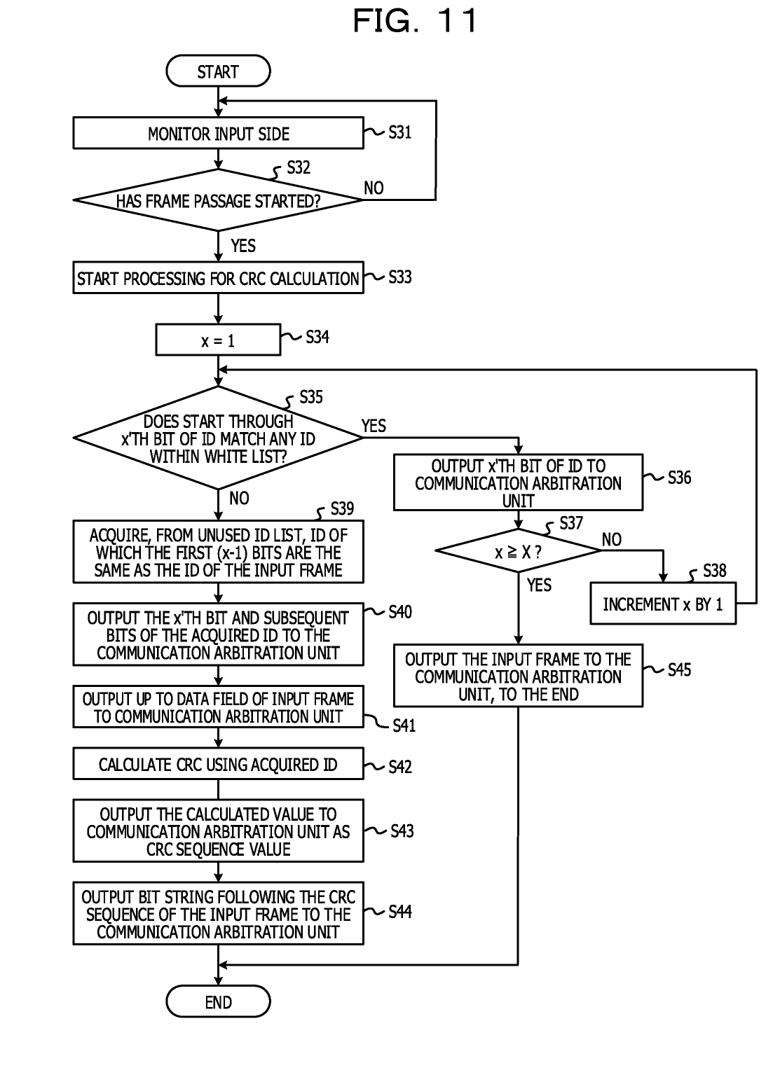

FIG. 11 is a flowchart for describing an example of processing performed at the control units 50. Note that the processing illustrated in FIG. 11 is only an example, and the processing may be changed depending on the implementation, such as the order of performing the processing of steps S33 and S34 being changed, for example.

The comparator 32 monitors data input from the wiring between itself and the CAN transceiver 21 which is the input side for frames, and determines whether or not passage of a frame has started (steps S31 and S32). Determination of whether passage of a frame has started or not is the same as the processing described with reference to FIG. 9. When passage of a frame starts, the comparator 32 performs settings so that data output to the communication arbitration unit 22 is also output to the CRC calculator 51, to start processing for CRC calculation (Yes in step S32, step S33). The settings in step S33 are performed by setting a selector (omitted from illustration) provided to the wiring of the communication arbitration unit 22, CRC calculator 51, comparator 32, and converter 31, for example. The selector is set such that the bit values output to the communication arbitration unit 22 from the comparator 32 and converter 31 are also output to the CRC calculator 51 as well, for example. The processing of steps S34 through S40 and S45 are the same as steps S13 through S19 and S21 described with reference to FIG. 9. Note that the constant X and the variable x used in FIG. 11 also are the same as those used in FIG. 9.

Upon output of the ID from the converter 31 to the communication arbitration unit 22 ending, the comparator 32 outputs the portion of the input frame from the RTR through the data field to the communication arbitration unit 22 (step S41). The CRC calculator 51 calculates the CRC sequence value using the ID value output to the communication arbitration unit 22 and the data field value (step S42). The CRC calculator 51 further outputs the obtained results to the communication arbitration unit 22 as the CRC sequence value (step S43). Thereafter, the comparator 32 outputs subsequent values after the CRC sequence in the input frame to the communication arbitration unit 22 (step S44).

Thus, frames input to the communication arbitration unit 22 have had the ID (first identification information) changed to an ID not received at any of the ECUs 5 (second identification information) by the processing in steps S39 and S40. Further, the CRC sequence value is also changed in accordance with the ID change by the processing in steps S42 and S43. Accordingly, using the second embodiment enables the system to be protected from attacks using unauthorized frames, in the same way as with the first embodiment, and further, no errors occur even if the ECUs 5 perform checks using the CRC.

### Third Embodiment

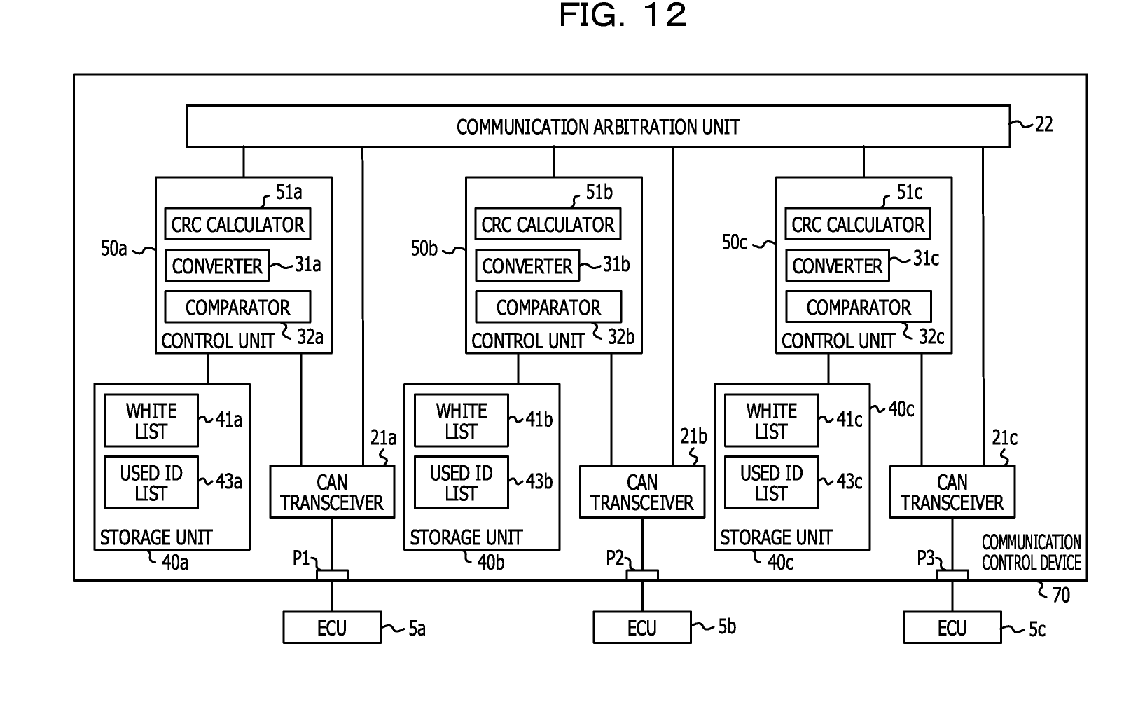

FIG. 12 illustrates an example of the configuration of a communication control device 70 according to a third embodiment. The communication control device 70 includes ports (P1, P2, and P3), CAN transceivers 21 (21a, 21b, and 21c), the communication arbitration unit 22, control units 50 (50a, 50b, and 50c), and storage units 40 (40a, 40b, and 40c). The operations of the CAN transceivers 21, communication arbitration unit 22, and control units 50, are the same as in the second embodiment. In the third embodiment, the storage units 40 each store a white list 41 and a used ID list 43. Accordingly, the converters 31 use the used ID lists 43 to identify identification information that will not be received at any ECU 5.

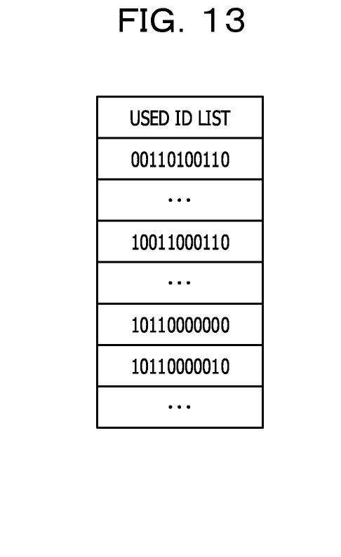

FIG. 13 illustrates an example of the used ID list 43. The used ID list 43 includes identification information that is to be the object of reception an any one of the ECUs 5 coupled to the communication control device 70. Note that the used ID list 43 may store just the identification information that is to be the object of reception, as illustrated in FIG. 13, or may store information where the identification information and the identification information of the ECU 5 that will receive frames of that identification information have been correlated.

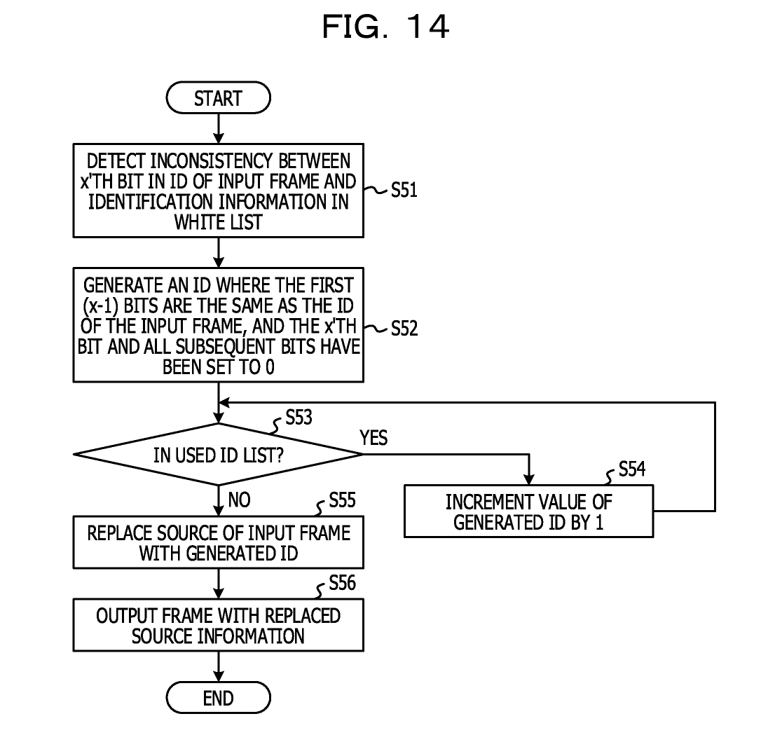

FIG. 14 is a flowchart for describing an example of processing performed at the control units 50. Assumption will be made that in step S51, the comparator 32 has detected that the ID does not match any identification information in the white list 41, by the processing regarding the x'th bit of the ID in the input frame. The comparator 32 notifies the converter 31 of reception of an unauthorized frame. The (x−1) bits of the first identification information that have been processed before detection that the frame is an unauthorized frame have already been output to the communication arbitration unit 22, as described in the first and second embodiments.

The converter 31 generates an ID where the first (x−1) bits are the same as the ID of the input frame, and the X'th bit and thereafter are all set to 0 (step S52). Further, the converter 31 determines whether or not the generated ID is included in the used ID list 43 (step S53). In a case where the generated ID is included in the used ID list 43, the converter 31 increments the value of the generated ID by 1, and returns to step S53 (Yes in step S53, step S54). The converter 31 repeats the processing of steps S53 and S54 until an ID not included in the used ID list 43 is detected.

In a case where the generated ID is not included in the used ID list 43, the converter 31 replaces the information of the source that has been input with the ID that has been obtained (No in step S53, step S55). That is to say, in step S55 the converter 31 replaces the ID by outputting to the communication arbitration unit 22 the x'th bit and subsequent bits of the ID regarding which determination is made that it is not included in the used ID list 43. Thereafter, the control unit 50 performs processing to output the second frame, regarding which the information of the transmission source has been replaced, to the communication arbitration unit 22 (step S56). Note that detailed processing performed in step S56 is the same as that in steps S41 through S43 described with reference to FIG. 11.

According to the third embodiment, transfer of unauthorized frames can be avoided in the same way as with the first and second embodiments, by sorting IDs used at any one of the ECUs 5 coupled to the communication control device 70 as a used ID list 43. In a case where the number of ECUs 5 coupled to the communication control device 70 is small, or the number of types of IDs received by the ECUs 5 coupled to the communication control device 70 is small, the amount of data of the used ID list 43 will be smaller than the amount of data of the unused ID list 42. Accordingly, the amount of information stored can be reduced by the converter 31 deciding the ID to use for transfer processing using the used ID list 43, as compared to using the unused ID list 42. Consequently, using the used ID list 43 enables the available amount of memory which the communication control device 70 can use for processing to be increased in the third embodiment as compared to the first and second embodiments.

### Fourth Embodiment

A case will be described in the fourth embodiment where a CRC is obtained in a manner correlated with an unused ID beforehand, so that the CRC in the frame output as a substitute for the unauthorized first frame will be a correct value even when using a communication control device 20 (FIG. 4) not having a control unit 50.

For example, in a case where bits in the data field of the second frame input to the communication arbitration unit 22 as a substitute for the unauthorized first frame are to be set to a predetermined value, a CRC is uniquely decided according to the ID to be used for the second frame. Accordingly, the unused ID list 42 may store the calculate value of the CRC calculated using the predetermined data, in a correlated manner. The second frame may be without a data field. For example, a unused ID list 42 storing the calculated value of a CRC in a case where there is not data field may correlate the unused ID, data content, and CRC as follows.

(Unused ID,data,CRC)

(00010001010,none,CRC1)

(10101101101,none,CRC2)

(11010010010,none,CRC3)

The method of detecting unauthorized frames is the same in the fourth embodiment as in the first embodiment. When detection is made that the first frame is an unauthorized frame, the converter 31 selects from the unused ID list 42 an unused ID that is identification information that will not be received by any of the ECUs 5, and that includes the bit string already output to the communication arbitration unit 22 at the start thereof. Following the output to the communication arbitration unit 22 of the bits of the selected unused ID that were not yet output, the converter 31 outputs the data and CRC values correlated to the selected unused ID to the communication arbitration unit 22. Upon the processing at the converter 31 ending, the comparator 32 outputs the values following the CRC to the communication arbitration unit 22. The values of the frame following the CRC are the same values for all frames, and are stored in the storage unit 40 beforehand.

By performing such processing, the CRC in the second frame is changed according to the ID even if the system uses the communication control device 20, so no errors occur even if the ECUs 5 perform CRC calculation. Further, the converter 31 and comparator 32 do not use bits following the bit at which determination has been made that the first frame is an unauthorized frame, and the unauthorized first frame is discarded, reducing processing load on the converter 31 and the comparator 32.

Others

While description has been made above by way of an example of a case where frames according to normal CAN specifications are transmitted and received, the above-described embodiments may also be applied to cases where frames according to extended CAN specifications and frames used in CAN with Flexible Data-Rate (CAN FD) are transmitted and received.

A processor may be included in the communication control device 20, 60, and 70, as the selection circuit 101 and processing circuit 102. In this case, the processor reads out a program stored in the memory 103, and realizes the communication arbitration unit 22 and control unit 30 or control unit 50.

The formats of the lists and frames used in the above description are only exemplary; information components included in the lists and frames may be changed in accordance with implementation.

While description has been made above regarding an example of a case where, upon detecting an unauthorized frame, the comparator 32 notifies the converter 31 of the bit string of the ID of the unauthorized frame that has already been output to the communication arbitration unit 22, but the method by which the converter 31 acquires the bit string may be changed according to implementation. For example, the converter 31 may monitor the values of bits output from the comparator 32 to the communication arbitration unit 22, and acquire a bit string output from the comparator 32 to the communication arbitration unit 22 after the SOF. The comparator 32 may output the bit string in the ID to the communication arbitration unit 22 and the converter 31. In a case where the converter 31 monitors bits output from the comparator 32, the converter 31 resets the ID value every time an SOF is detected.

Further, depending on the implementation, the comparator 32 may output the values of bits to be compared to the communication arbitration unit 22, in parallel with the comparison processing. In this case, when an unauthorized frame is detected in comparison of the x'th bit from the start of the ID, the bit string from the first bit of the ID to the x'th bit has been output to the communication arbitration unit 22. Accordingly, the converter 31 sets the ID of the second frame to identification information in which the bit string from the first bit to the x'th bit is the same ID as the ID of the unauthorized frame, and which will not be received at any of the ECUs 5.

While description has been made in the third embodiment that the communication control device 70 includes control units 50, the communication control device 70 may include control units 30 instead of control units 50.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication control device including a plurality of ports, the communication control device comprising:
a memory configured to store one or more pieces of identification information correlated with each of one or more of the plurality of ports to which a communication device has been coupled, the one or more pieces of identification information being included in a frame for transmission of the frame by one or more communication devices each coupled to the one or more ports; and
a processor configured to:
when first identification information for identifying a first frame in the first frame received at a first port of the one or more ports is not stored in the memory correlated with the first port, output, to the plurality of ports, a second frame in which has been set second identification information regarding which determination will be made at the one or more communication devices that the second frame is to be discarded, instead of the first identification information.

2. The communication control device according to claim 1, wherein the processor is configured to:
compare identification information correlated with the first port from the first bit of the first identification information,
output the bit which is the object of comparison in the first identification information toward the plurality of ports when it is determined that a bit string from the first bit to the bit which is the object of comparison matches part of identification information correlated to the first port, and
determine the second identification information including the bit string in the first identification information that has already been output when it is determined that the bit string does not match any portion of the identification information correlated with the first port.

3. The communication control device according to claim 2, wherein the processor is configured to:
change information used in error checking in the first frame, to a value used in error checking regarding a frame including data in the first frame and the second identification information.

4. The communication control device according to claim 1, wherein
the memory is configured to store a list of identification information that will be determined to be the object of being discarded at the one or more communication devices, and
the processor is configured to select the second identification information from the identification information in the list.

5. The communication control device according to claim 1, wherein
the memory is configured to store a list of identification information that will be received by at least one of the one or more communication devices, and
the processor is configured to:
determine a first candidate as a candidate for the second identification information,
determine the second identification information to be the first candidate when it is determined that the first candidate is not included in the list,
generate a second candidate as a candidate for the second identification information when it is determined that the first candidate is included in the list, and
determine whether the second candidate is included in the list.

6. A method of communicating a frame executed in a communication control device including a plurality of ports and a memory, the method comprising:
receiving a first frame at a first port of one or more ports of the plurality of ports to which a communication device has been coupled;
determining whether first identification information for identifying a first frame in the first frame is not stored in the memory correlated with the first port, the memory storing one or more pieces of identification information correlated with each of one or more of the plurality of ports to which a communication device has been coupled, the one or more pieces of identification information being included in a frame for transmission of the frame by one or more communication devices each coupled to the one or more ports; and
when it is determined that the first identification information is not stored in the memory correlated with the first port, outputting, to the plurality of ports, a second frame in which has been set second identification information regarding which determination will be made at the one or more communication devices that the second frame is to be discarded, instead of the first identification information.

7. The method according to claim 6, further comprising:
comparing identification information correlated with the first port from the first bit of the first identification information;
outputting the bit which is the object of comparison in the first identification information toward the plurality of ports when it is determined that a bit string from the first bit to the bit which is the object of comparison matches part of identification information correlated to the first port; and
determining the second identification information including the bit string in the first identification information that has already been output when it is determined that the bit string does not match any portion of the identification information correlated with the first port.

8. The method according to claim 7, further comprising:
changing information used in error checking in the first frame, to a value used in error checking regarding a frame including data in the first frame and the second identification information.

9. The method according to claim 6, wherein
the memory is configured to store a list of identification information that will be determined to be the object of being discarded at the one or more communication devices, and
the method further includes:
selecting the second identification information from the identification information in the list.

10. The method according to claim 6, wherein
the memory is configured to store a list of identification information that will be received by at least one of the one or more communication devices, and
the method further includes:
determining a first candidate as a candidate for the second identification information;
determining the second identification information to be the first candidate when it is determined that the first candidate is not included in the list;
generating a second candidate as a candidate for the second identification information when it is determined that the first candidate is included in the list; and
determining whether the second candidate is included in the list.

11. A non-transitory computer-readable storage medium that stores a program for causing a communication control device including a plurality of ports and a memory to execute a process, the process comprising:
determining first identification information for identifying a first frame in the first frame received at a first port of the one or more ports is not stored in the memory correlated with the first port, the memory storing one or more pieces of identification information correlated with each of one or more of the plurality of ports to which a communication device has been coupled, the one or more pieces of identification information being included in a frame for transmission of the frame by one or more communication devices each coupled to the one or more ports, and
when it is determined that the first identification information is not stored in the memory correlated with the first port, outputting, to the plurality of ports, a second frame in which has been set second identification information regarding which determination will be made at the one or more communication devices that the second frame is to be discarded, instead of the first identification information.

12. The non-transitory storage medium according to claim 11, wherein the process further comprising:
comparing identification information correlated with the first port from the first bit of the first identification information,
outputting the bit which is the object of comparison in the first identification information toward the plurality of ports when it is determined that a bit string from the first bit to the bit which is the object of comparison matches part of identification information correlated to the first port, and
determining the second identification information including the bit string in the first identification information that has already been output when it is determined that the bit string does not match any portion of the identification information correlated with the first port.

13. The non-transitory storage medium according to claim 12, wherein the process further comprising:
changing information used in error checking in the first frame, to a value used in error checking regarding a frame including data in the first frame and the second identification information.

14. The non-transitory storage medium according to claim 11, wherein
the memory is configured to store a list of identification information that will be determined to be the object of being discarded at the one or more communication devices, and
the process further includes:
selecting the second identification information from the identification information in the list.

15. The non-transitory storage medium according to claim 11, wherein
the memory is configured to store a list of identification information that will be received by at least one of the one or more communication devices, and
the process further includes:
determining a first candidate as a candidate for the second identification information;
determining the second identification information to be the first candidate when it is determined that the first candidate is not included in the list;
generating a second candidate as a candidate for the second identification information when it is determined that the first candidate is included in the list; and
determining whether the second candidate is included in the list.
